(19) United States
(12) Patent Application Publication
(10) Pub. No.: US 2025/0224382 A1
(43) Pub. Date: Jul. 10, 2025

(54) PROBE AND METHOD FOR NON-DESTRUCTIVE TESTING OF A COMPONENT

(71) Applicant: ROLLS-ROYCE plc, London (GB)

(72) Inventors: Mohamed Ghareb Buomy ATIA, Nottingham (GB); Erhui SUN, Nottingham (GB); Xin DONG, Nottingham (GB); Andrew D. NORTON, Derby (GB); Dragos A. AXINTE, Nottingham (GB); Abdelkhalick MOHAMMAD, Nottingham (GB)

(73) Assignee: ROLLS-ROYCE plc, London (GB)

(21) Appl. No.: 18/747,619

(22) Filed: Jun. 19, 2024

(30) Foreign Application Priority Data
Jul. 13, 2023 (GB) 2310732.9

(51) Int. Cl. G01N 29/24; G01M 15/14; G01N 29/28

(52) U.S. Cl. CPC G01N 29/24; G01M 15/14; G01N 29/28

(57) ABSTRACT

A probe for non-destructive testing of a component. The probe includes a head configured to transmit a signal or a wave to a surface of the component for non-destructive testing of the component. The head includes a first head end facing away from the component and an opposing second head end facing the component. The probe further includes a tube spaced apart from the head and including a first tube end distal to the head and an opposing second tube end proximal to the head. The tube defines an internal passage therein extending between the first tube end and the second tube end. The probe further includes a flexible actuator disposed between the head and the tube. The flexible actuator is configured to be actuated between a non-actuated state and an actuated state.

### CROSS-REFERENCE TO RELATED APPLICATIONS

This specification is based upon and claims the benefit of priority from United Kingdom patent application GB 2310732.9 filed on Jul. 13, 2023, the entire contents of which is incorporated herein by reference.

### BACKGROUND

### Technical Field

The present disclosure generally relates to a probe and a method for non-destructive testing of a component.

### Description of the Related Art

Non-destructive material testing using probes for detection of shrinkage, cracks and other flaws in the interior of a component is well known. Probes are also commonly used for non-destructive in situ testing of components, especially gas turbine engine components, such as turbine blades or compressor blades. Probes may use ultrasonic waves for the non-destructive testing of a component.

In many applications, probes are required to operate at a confined space which may put limitations on their movement. In such confined spaces, conventional probes may not operate effectively due to such limitations on the movement. Further, for accurate testing of the component, there is a need that the probe maintains substantially continuous contact with the component. Moreover, when a surface of the component is curved, the conventional probes may not be able to inspect every portion of the curved component, and therefore, may not detect worn or damaged areas in the component.

Thus, the conventional probes may not work effectively and efficiently in the confined spaces, which may lead to undiscovered cracks of a target component, such as a component of a prime mover. If not discovered on time, such cracks may reduce lifetime of the prime mover and degrade the working of the prime mover. Hence, there is a need for a probe which can overcome above-mentioned drawbacks when used for non-destructive testing of a component.

### SUMMARY

According to a first aspect there is provided a probe for non-destructive testing of a component. The probe includes a head configured to transmit a signal or a wave (e.g. acoustic waves) to a surface of the component for non-destructive testing of the component. The head includes a first head end facing away from the component and an opposing second head end facing the component. The first head end is open. The probe further includes a tube spaced apart from the head. The tube includes a first tube end distal to the head and an opposing second tube end proximal to the head. Each of the first tube end and the second tube end is open. The tube defines an internal passage therein extending between the first tube end and the second tube end. The probe further includes a flexible actuator disposed between the head and the tube. The flexible actuator is attached with the first head end of the head and the second tube end of the tube. The flexible actuator defines a longitudinal axis along its length and configured to be actuated between a non-actuated state and an actuated state. In the non-actuated state, the flexible actuator extends for a non-actuated length along the longitudinal axis. In the actuated state, the flexible actuator expands axially along the longitudinal axis relative to the non-actuated state and extends for an actuated length along the longitudinal axis. The actuated length is greater than the non-actuated length. Upon switching the flexible actuator from the actuated state to the non-actuated state, the flexible actuator returns to the non-actuated length. The flexible actuator is remotely actuatable from the first tube end between the non-actuated state and the actuated state.

The actuation of the flexible actuator between the non-actuated state and the actuated state may allow the probe to be used for non-destructive testing of the component in confined spaces as well. As the actuated length is greater than the non-actuated length, the flexible actuator may remove limitations on a movement of the probe, especially for in-situ applications. As a result, the probe may be able to effectively determine cracks and other flaws in the interior of the component. Moreover, due to extension of the flexible actuator along the longitudinal axis, the probe of the present disclosure may be more effective as compared to conventional probes for non-destructive testing of a component with a curved surface. Therefore, the flexible actuator may improve effectiveness and increase efficiency of the probe of the present disclosure. The timely detection of cracks and irregularities in the component may also improve operational life of the component.

In some embodiments, the flexible actuator includes a tubular body extending along the longitudinal axis between a first body end facing the tube and an opposing second body end facing the head. The tubular body includes an inner annular portion defining an actuator passage therethrough and an outer annular portion disposed around the inner annular portion. The actuator passage fluidly connects the internal passage of the tube with the head. The inner annular portion and the outer annular portion define an internal volume therebetween, such that the tubular body is inflatable. The tubular body further includes an actuating pipe connected to the tubular body. The actuating pipe extends along the longitudinal axis from the tubular body towards the first tube end of the tube. The actuating pipe includes a first pipe end distal to the tubular body and an opposing second pipe end disposed in fluid communication with the internal volume of the tubular body. The actuating pipe is configured to receive a pressurized fluid through the first pipe end. Upon receiving the pressurized fluid within the internal volume of the tubular body, the tubular body inflates and axially expands along the longitudinal axis, thereby actuating the flexible actuator from the non-actuated state to the actuated state.

The actuating pipe allows the tubular body to receive the pressurized fluid within the internal volume. The pressurized fluid within the internal volume allows the tubular body to inflate and axially expand along the longitudinal axis. In some cases., the tubular body may be a cylindrical shaped body. In some other cases, the tubular body may have a shape different than the cylindrical shape. In some cases, the tubular body may include a polygonal shape, instead of a cylindrical shape. As the actuator passage fluidly connects the internal passage of the tube with the head, the actuator passage is used to bypass any cables and/or additional pipes extending from the tube to a sensor (e.g., an ultrasonic sensor) disposed in the head. Specifically, the actuator passage may at least partially receive such cables and/or additional pipes therethrough.

In some embodiments, the tubular body further includes a first end wall disposed at the first body end and a second end wall disposed at the second body end. The first end wall is connected to the actuating pipe. The first end wall and the second end wall together delimit the internal volume. The first end wall defines an opening therethrough disposed in fluid communication with the first pipe end and the internal volume. The opening defined in the first end wall allows fluid communication between the first pipe end and the internal volume. In this way, the pressurized fluid is received within the internal volume of the tubular body of the flexible actuator.

In some embodiments, the probe further includes a fluid pipe at least partially received within the internal passage via the first tube end. The fluid pipe is fluidly connected to the first pipe end of the actuating pipe. The fluid pipe is configured to supply the pressurized fluid to the actuating pipe via the first pipe end, such that the flexible actuator is remotely actuatable by the fluid pipe. The fluid may be water or air, or any other gas or liquid based on application requirements.

In some embodiments, the probe further includes a pumping device disposed in fluid communication with the fluid pipe and located outside the tube. The pumping device is configured to supply the pressurized fluid to the fluid pipe. The pumping device may supply the pressurized fluid at a set pressure based on application requirements. In some cases, the pumping device may be an air syringe to supply pressurized air to the fluid pipe. In some cases, the pumping device may be a hydraulic pump to supply pressurized water to the fluid pipe. The pumping device may be manually operated or controlled via an electrical or electronic system.

In some embodiments, the tubular body includes a cylindrical outer surface extending along the longitudinal axis. The tubular body further includes a plurality of annular ribs disposed on the cylindrical outer surface and spaced apart from each other with respect to the longitudinal axis. The plurality of annular ribs defines a plurality of annular grooves therebetween, such that each pair of adjacent annular ribs from the plurality of annular ribs defines therebetween a corresponding annular groove from the plurality of annular grooves. The plurality of annular ribs includes a first annular rib disposed proximal to the first body end of the tubular body and a second annular rib disposed proximal to the second body end of the tubular body. In some cases, the plurality of annular ribs includes a total of three annular ribs and the plurality of annular grooves includes a total of two annular grooves. In some cases, the plurality of annular ribs includes more than three annular ribs and the plurality of annular grooves includes more than two annular grooves. A count of the plurality of annular ribs and corresponding plurality of annular grooves may depend on application requirements. The annular ribs may be discrete or connected annular ribs.

In some embodiments, the probe further includes a plurality of rings corresponding to the plurality of annular grooves and disposed around the cylindrical outer surface of the tubular body. Each ring from the plurality of rings is at least partially received within the corresponding annular groove. The plurality of rings is configured to restrict a radial expansion of the tubular body perpendicular to the longitudinal axis in response to the inflation by the pressurized fluid. In other words, the plurality of rings may allow smooth switching of the flexible actuator between the non-actuated state and the actuated state by allowing only axial movement of the flexible actuator along the longitudinal axis. In some cases, the plurality of rings includes a total of two rings corresponding to two annular grooves from the plurality of annular grooves. A count of the plurality of annular ribs, the plurality of annular grooves, and the plurality of rings may be decided based on a required stiffness of the flexible actuator for a particular application.

In some embodiments, each ring is made of a rigid material. The rigid material of each ring may facilitate the restriction of radial expansion of the tubular body perpendicular to the longitudinal axis in response to the inflation by the pressurized fluid.

In some embodiments, the tubular body further includes a wide tubular portion extending along the longitudinal axis and defining the first body end and the cylindrical outer surface. The tubular body further includes a narrow tubular portion extending from the wide tubular portion along the longitudinal axis and defining the second body end. The wide tubular portion includes an annular step surface circumferentially disposed around the narrow tubular portion. The wide tubular portion includes a first end section extending between the first body end and the first annular rib. The wide tubular portion further includes a second end section extending between the annular step surface and the second annular rib. The wide tubular portion and the narrow tubular portion together form a continuous cylindrical internal surface that defines the actuator passage. The continuous cylindrical internal surface extends between the first body end and the second body end. A maximum diameter of the wide tubular portion is greater than a maximum diameter of the narrow tubular portion. When the internal volume is filled with the pressurized fluid, the wide annular portion inflates and axially expands along the longitudinal axis, thereby actuating the flexible actuator from the non-actuated state to the actuated state. Further, the dimensions of the wide tubular portion and the narrow tubular portion may be selected based on corresponding dimensions of the tube and the head.

In some embodiments, the probe further includes a first cover attaching the tubular body to the second tube end. The first cover includes an annular body. The annular body includes a first open end facing the second tube end of the tube, an opposing second open end, a first end surface disposed at the first open end, a second end surface disposed at the second open end, and an internal surface extending between the first end surface and the second end surface. The first cover further includes an annular stop radially extending from the internal surface of the annular body and disposed proximal to the second end surface. The annular stop includes a circumferential cut-out. The first cover further includes a recess disposed on the internal surface of the annular body. The recess extends from the circumferential cut-out to the first end surface. The first end surface of the annular body is attached to the second tube end of the tube. The annular body receives therein the first end section of the wide tubular portion via the second open end, such that the first end section engages with the annular stop and the first annular rib engages with the second end surface. The first cover functions as a connector to easily connect/disconnect the flexible actuator and the tube. The annular stop, the circumferential cut-out, and the recess may facilitate attachment of the tube and the flexible actuator. The circumferential cut-out fluidly communicates the internal passage and the actuator passage. The recess is configured to receive a portion of the actuating pipe. The first cover may be attached to the tubular body of the flexible actuator by friction fit, or gluing. The first cover may be attached to the second tube end of the tube by gluing, or other commonly known joining techniques.

In some embodiments, a thickness of the first end surface is greater than a 1 thickness of the second end surface. The internal surface includes a narrow surface portion extending from the first end surface to the annular stop. The internal surface further includes a wide surface portion extending from the annular stop to the second end surface. Dimensions of the narrow surface portion and the wide surface portion are selected so as to allow precise attachment between the tube and the flexible actuator.

In some embodiments, the recess tapers from the circumferential cut-out to the first end surface. The tapered portion of the recess may allow the actuating pipe to at least partially extend through the recess.

In some embodiments, the probe further includes a second cover attaching the tubular body to the head. The second cover includes a narrow annular portion and a wide annular portion disposed around and extending at least partially from the narrow annular portion. The narrow annular portion includes an inner annular step surface extending circumferentially within the wide annular portion. The wide annular portion includes an outer annular step surface disposed circumferentially around the narrow annular portion. The narrow annular portion at least partially receives therein the narrow tubular portion of the tubular body, such that the inner annular step surface engages with the annular step surface of the wide tubular portion. The wide annular portion receives therein the second end section of the wide tubular portion, such that the wide annular portion engages with the second annular rib. The narrow annular portion is at least partially received within the head via the first head end. The second cover functions as a connector to easily connect/disconnect the flexible actuator and the head. The second cover may be attached to the tubular body of the flexible actuator by friction fit, or gluing. The second cover may be attached to the first head end of the head by friction fit, gluing, or other commonly known joining techniques.

Therefore, the first cover and the second cover function as connectors for attaching the flexible actuator to the tube and the head, respectively.

In some embodiments, the flexible actuator is integrally manufactured by additive manufacturing. This may increase manufacturing agility of the flexible actuator. Moreover, the integral manufacturing of the flexible actuator by additive manufacturing may be less costly process as compared to other alternatives.

In some embodiments, the flexible actuator is made of an elastomeric material. The elastomeric material facilitates inflation and axial expansion of the tubular body along the longitudinal axis.

In some embodiments, the elastomeric material is silicone. In some cases, the elastomeric material may be rubber.

In some embodiments, the probe is an ultrasonic probe that is configured to transmit ultrasonic waves to the surface of the component. The head of the ultrasonic probe may include an ultrasonic sensor to transmit the ultrasonic waves to the surface of the component.

According to a second aspect, there is provided a method for non-destructive testing of a component using the probe of the first aspect. The method includes disposing, via the tube, the head proximal to a surface of the component. The method further includes actuating the flexible actuator from the non-actuated state to the actuated state, such that the second head end of the head is in contact with the surface of the component. The method further includes transmitting a signal or a wave (e.g. acoustic waves) from the head to the surface of the component. The method of the present disclosure may allow the probe to be used in a confined space. The method of the present disclosure may also remove limitations on the movement of the probe as the flexible actuator extends for the actuated length in the actuated state. The method of the present disclosure further allows effective non-destructive testing of a component with a curved surface.

In some embodiments, the component is an engine component. The probe and the method of the present disclosure may allow improved working efficiency and increased operating life of the engine component by efficient and accurate non-destructive testing of the engine component.

In some embodiments, the engine component is a component of a gas turbine engine. The probe and the method of the present disclosure may allow improved performance of the gas turbine engine by timely determining the cracks and irregularities in the component of the gas turbine engine.

In some embodiments, the component is a component of a pipeline, a nuclear plant, or a chemical plant. The probe and the method of the present disclosure may allow improved performance of the pipeline, the nuclear plant, or the chemical plant by efficient and accurate non-destructive testing of the component of the pipeline, the nuclear plant, or the chemical plant.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed). The gearbox may be a reduction gearbox (in that the output to the fan is a lower rotational rate than the input from the core shaft). Any type of gearbox may be used.

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. The bypass duct may be substantially annular. The bypass duct may be radially outside the engine core. The radially outer surface of the bypass duct may be defined by a nacelle and/or a fan case.

Specific thrust of an engine may be defined as the net thrust of the engine divided by the total mass flow through the engine. At cruise conditions, the specific thrust of an engine described and/or claimed herein may be less than (or on the order of) any of the following: 110 Nkg-1 s, 105 Nkg-1 s, 100 Nkg-1 s, 95 Nkg-1 s, 90 Nkg-1 s, 85 Nkg-1 s or 80 Nkg-1 s. The specific thrust may be in an inclusive range bounded by any two of the values in the previous sentence (i.e. the values may form upper or lower bounds), for example in the range of from 80 Nkg-1 s to 100 Nkg-1 s, or 85 Nkg-1 s to 95 Nkg-1 s. Such engines may be particularly efficient in comparison with conventional gas turbine engines.

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre.

The fan of a gas turbine as described and/or claimed herein may have any desired number of fan blades, for example 14, 16, 18, 20, 22, 24 or 26 fan blades.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 is a sectional side view of a gas turbine engine;

FIG. 2A is a schematic side view of a probe for non-destructive testing of a component, wherein a flexible actuator of the probe is shown in a non-actuated state;

FIG. 2B is a schematic side view of the probe of FIG. 2A, wherein the flexible actuator is shown in an actuated state;

FIG. 3A is a partial schematic side view of the probe of FIG. 2A;

FIG. 3B is a partial exploded view of the probe of FIG. 2A;

FIG. 3C is a partial sectional side perspective view of the probe of FIG. 2A;

FIG. 4A is a perspective front view of the flexible actuator of the probe of FIG. 2A;

FIG. 4B is a side view of the flexible actuator of FIG. 4A in the non-actuated state;

FIG. 4C is a side view of the flexible actuator of FIG. 4A in the actuated state;

FIG. 4D is a sectional side view of the flexible actuator of FIG. 4A in the non-actuated state;

FIG. 4E is a perspective sectional view of the flexible actuator of FIG. 4B, taken along a line A-A′;

FIG. 4F is a perspective sectional view of the flexible actuator of FIG. 4B, taken along a line B-B′;

FIG. 5A is a side view of an assembly of the flexible actuator, a first cover, and a second cover of the probe of FIG. 2A;

FIG. 5B is an exploded view of the assembly of FIG. 5A;

FIG. 5C is a perspective front view of the assembly of FIG. 5A;

FIG. 5D is a front view of the assembly of FIG. 5A;

FIG. 6A is a front perspective view of the first cover of FIG. 5A;

FIG. 6B is a rear perspective view of the first cover of FIG. 6A;

FIG. 6C is a front view of the first cover of FIG. 6A;

FIG. 6 D is a rear view of the first cover of FIG. 6A;

FIG. 7A is a front perspective view of the second cover of FIG. 5A;

FIG. 7B is a rear perspective view of the second cover of FIG. 7A; and

FIG. 8 is a flowchart illustrating a method for non-destructive testing of the component using the probe of FIG. 2A.

### DETAILED DESCRIPTION

Aspects and embodiments of the present disclosure will now be discussed with reference to the accompanying figures. Further aspects and embodiments will be apparent to those skilled in the art.

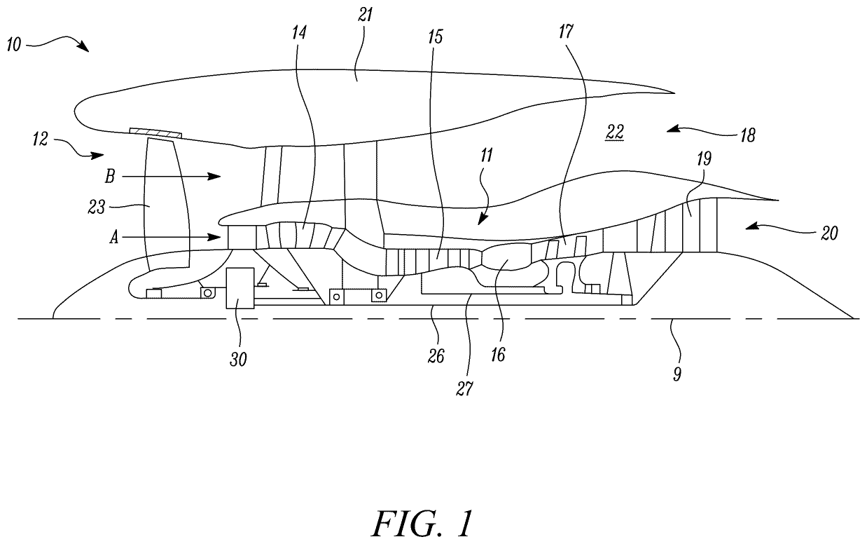

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high pressure compressor 15, combustion equipment 16, a high pressure turbine 17, a low pressure turbine 19, and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the core exhaust nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine 19” and “low pressure compressor 14” referred to herein may alternatively be known as the “intermediate pressure turbine 19” and “intermediate pressure compressor 14”, respectively. Where such alternative nomenclature is used, the fan 23 may be referred to as a first, or lowest pressure, compression stage.

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 18, 20 meaning that the flow through the bypass duct 22 has its own nozzle 18 that is separate to and radially outside the core exhaust nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

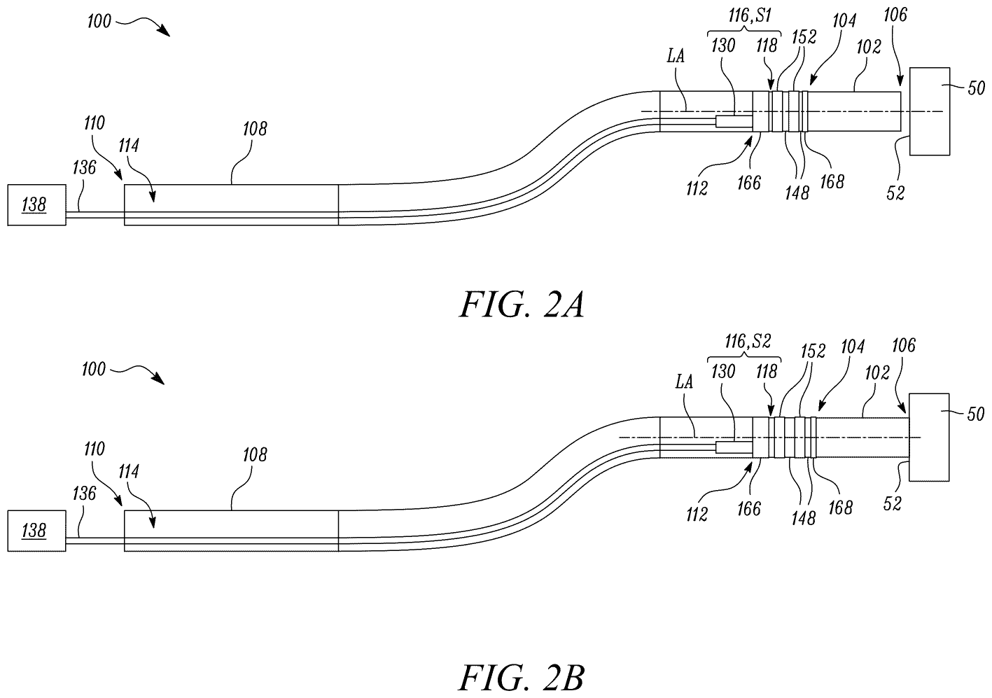

FIG. 2A is a schematic side view of a probe 100 for non-destructive testing of a component 50, according to an embodiment of the present disclosure. In some embodiments, the component 50 is an engine component. In some embodiments, the component 50 is a component of the gas turbine engine 10 shown in FIG. 1. In some embodiments, the component 50 is a component of a pipeline, a nuclear plant, or a chemical plant (not shown).

The probe 100 includes a head 102 configured to transmit a signal or a wave (e.g. acoustic waves) to a surface 52 of the component 50 for non-destructive testing of the component 50. In some embodiments, the probe 100 is an ultrasonic probe that is configured to transmit ultrasonic waves to the surface 52 of the component 50. In some embodiments, the head 102 may include an ultrasonic sensor to transmit ultrasonic waves to the surface 52 of the component 50 and thereby detect any cracks and irregularities in the component 50. The head 102 includes a first head end 104 facing away from the component 50 and an opposing second head end 106 facing the component 50. The first head end 104 is open.

The probe 100 further includes a tube 108 spaced apart from the head 102. The tube 108 is shown as transparent in FIGS. 2A and 2B for illustrative purposes. The tube 108 includes a first tube end 110 distal to the head 102 and an opposing second tube end 112 proximal to the head 102. Each of the first tube end 110 and the second tube end 112 is open. The tube 108 defines an internal passage 114 therein extending between the first tube end 110 and the second tube end 112. In an embodiment, a sensor wire (not shown) associated with the ultrasonic sensor in the head 102 may pass through the internal passage 114.

The probe 100 further includes a flexible actuator 116 disposed between the head 102 and the tube 108. The flexible actuator 116 is attached with the first head end 104 of the head 102 and the second tube end 112 of the tube 108. The flexible actuator 116 defines a longitudinal axis LA along its length. The flexible actuator 116 is configured to be actuated between a non-actuated state S1 and an actuated state S2. In FIG. 2A, the flexible actuator 116 is shown in the non-actuated state S1. FIG. 2B is a schematic side view of the probe 100, wherein the flexible actuator 116 is shown in the actuated state S2, according to an embodiment of the present disclosure.

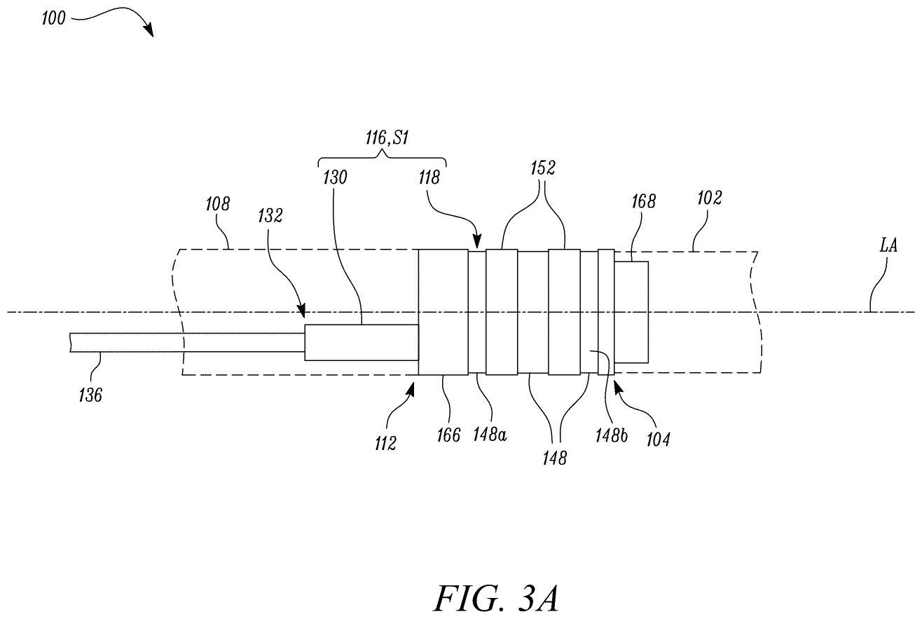

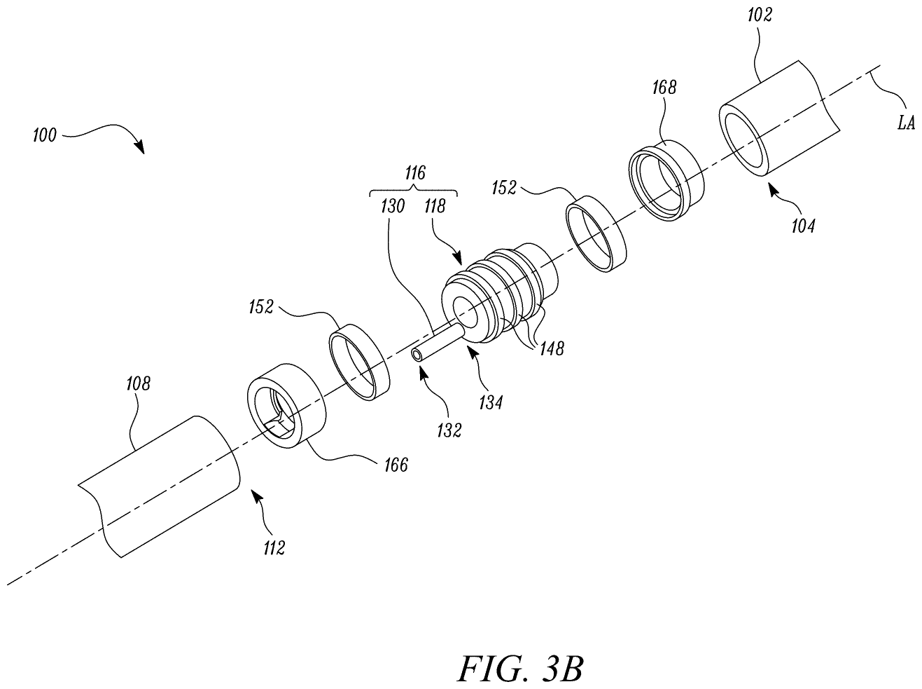

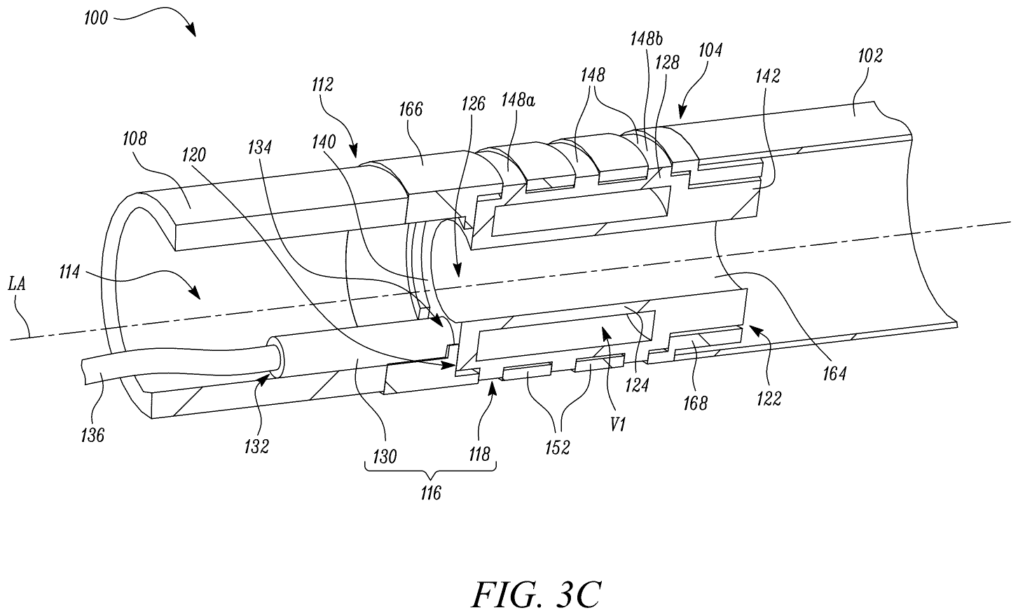

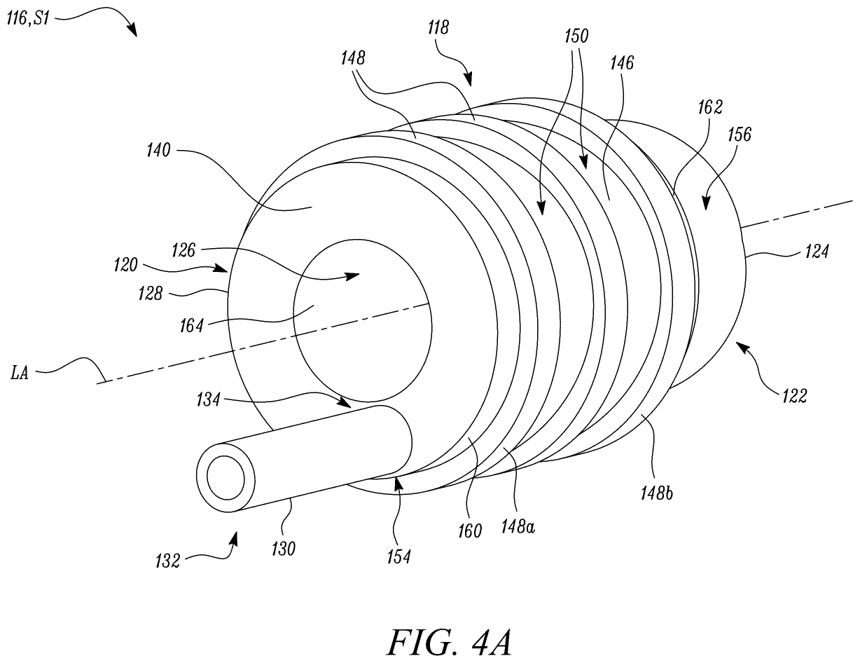

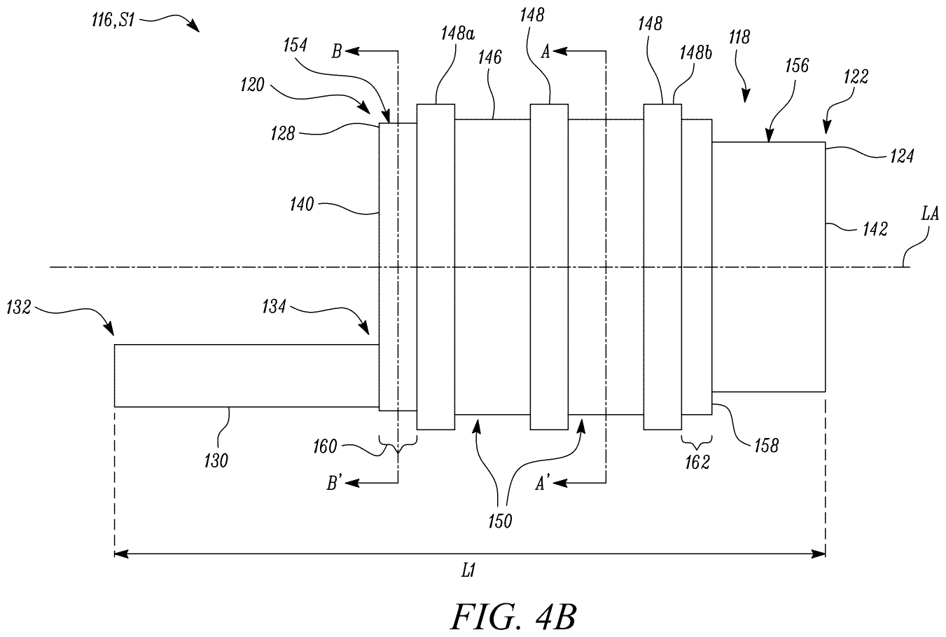

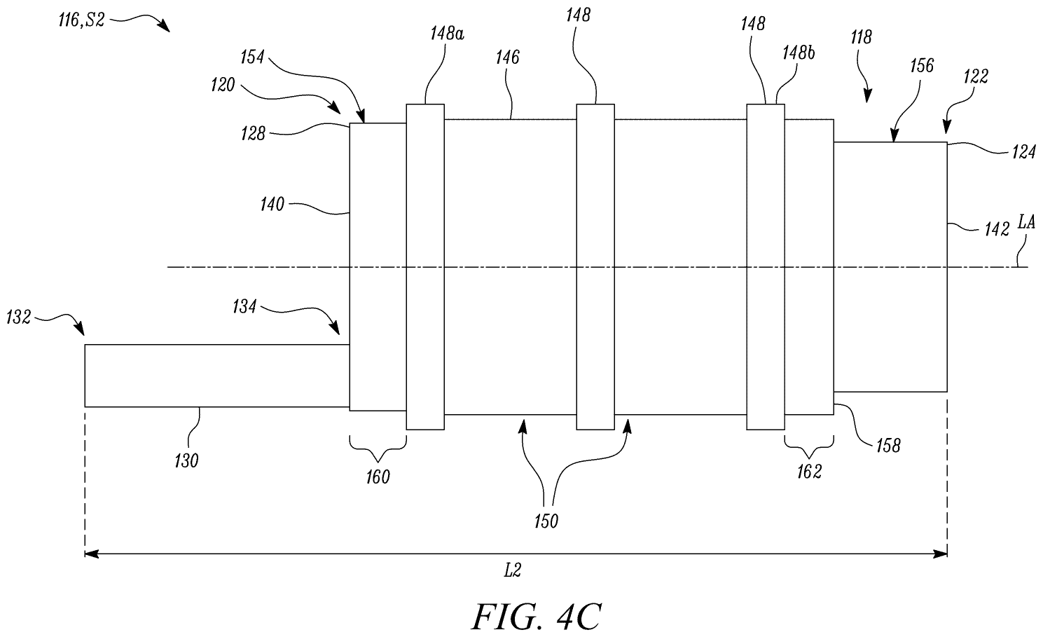

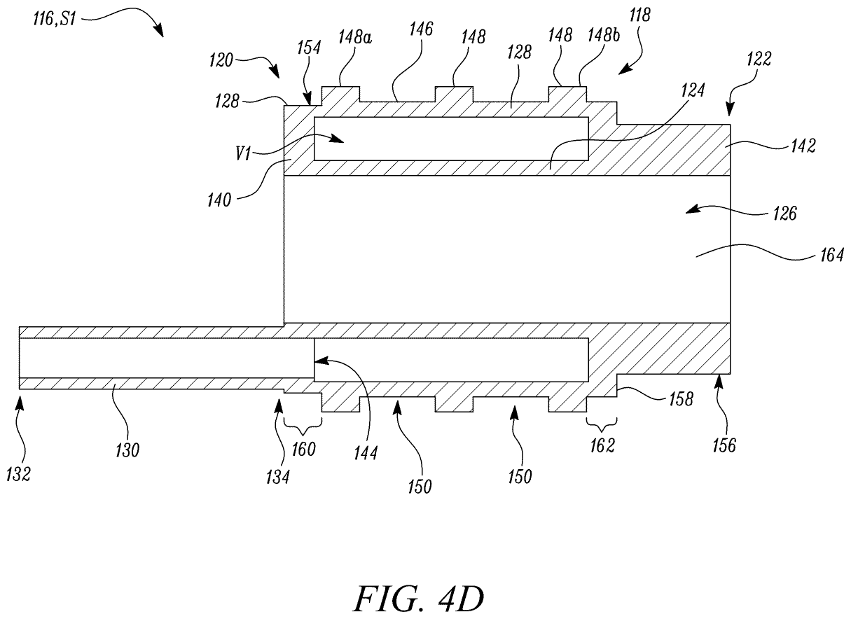

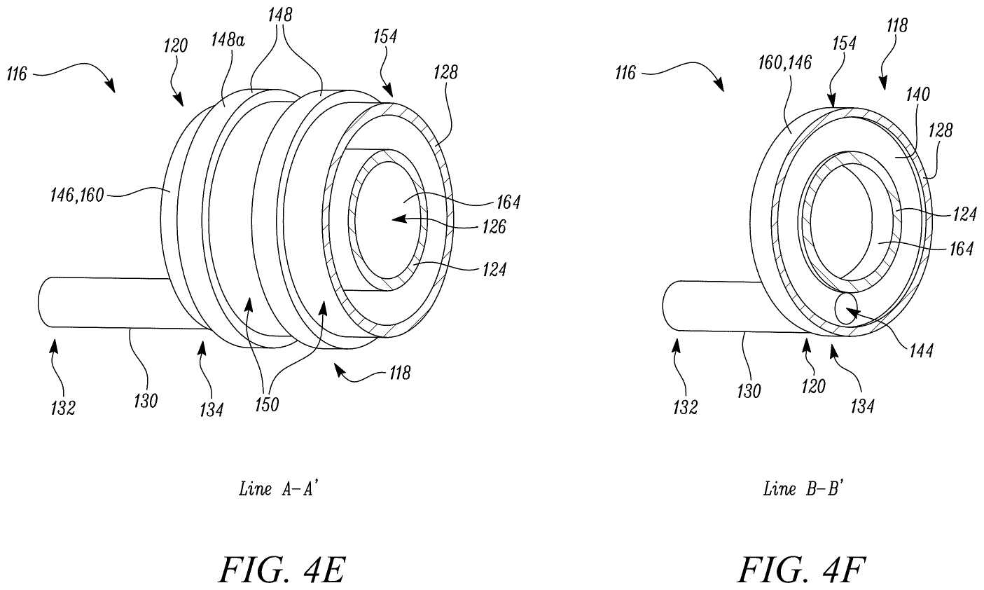

FIG. 3A is a partial schematic side view of the probe 100 of FIG. 2A, according to an embodiment of the present disclosure. FIG. 3B is a partial exploded view of the probe 100 of FIG. 2A, according to an embodiment of the present disclosure. The tube 108 and the head 102 are shown as transparent in FIG. 3B for illustrative purposes. FIG. 3C is a partial sectional side perspective view of the probe 100 of FIG. 2A, according to an embodiment of the present disclosure. FIG. 4A is a perspective front view of the flexible actuator 116, according to an embodiment of the present disclosure. FIG. 4B is a side view of the flexible actuator 116 in the non-actuated state S1, according to an embodiment of the present disclosure. FIG. 4C is a side view of the flexible actuator 116 in the actuated state S2, according to an embodiment of the present disclosure. FIG. 4D is a sectional side view of the flexible actuator 116 in the non-actuated state S1, according to an embodiment of the present disclosure. FIG. 4E is a perspective sectional view of the flexible actuator 116 of FIG. 4B, taken along a line A-A′, according to an embodiment of the present disclosure. FIG. 4F is a perspective sectional view of the flexible actuator 116 of FIG. 4B, taken along a line B-B′, according to an embodiment of the present disclosure.

Referring to FIGS. 2A to 4F, in the non-actuated state S1, the flexible actuator 116 extends for a non-actuated length L1 (shown in FIG. 4B) along the longitudinal axis LA. In the actuated state S2, the flexible actuator 116 expands axially along the longitudinal axis LA relative to the non-actuated state S1 and extends for an actuated length L2 (shown in FIG. 4C) along the longitudinal axis LA. The actuated length L2 is greater than the non-actuated length L1. In some embodiments, the actuated length L2 is greater than the non-actuated length L1 by about 5 mm. Upon switching the flexible actuator 116 from the actuated state S2 to the non-actuated state S1, the flexible actuator 116 returns to the non-actuated length L1. In other words, the non-actuated state S1 of the flexible actuator 116 is a default state of the flexible actuator 116. The flexible actuator 116 is remotely actuatable from the first tube end 110 between the non-actuated state S1 and the actuated state S2.

The flexible actuator 116 includes a tubular body 118 extending along the longitudinal axis LA between a first body end 120 facing the tube 108 and an opposing second body end 122 facing the head 102. The tubular body 118 includes an inner annular portion 124 defining an actuator passage 126 therethrough. The tubular body 118 further includes an outer annular portion 128 disposed around the inner annular portion 124. The actuator passage 126 fluidly connects the internal passage 114 of the tube 108 with the head 102. The inner annular portion 124 and the outer annular portion 128 define an internal volume V1 (shown in FIG. 3C) therebetween, such that the tubular body 118 is inflatable. In some embodiments, the tubular body 118 may be a cylindrical shaped body. In some other embodiments, the tubular body 118 may have a shape different than the cylindrical shape.

The flexible actuator 116 further includes an actuating pipe 130 connected to the tubular body 118. In some embodiments, the flexible actuator 116 is integrally manufactured by additive manufacturing. In some embodiments, the actuating pipe 130 may be connected to the tubular body 118 by welding, or other joining methods. The actuating pipe 130 extends along the longitudinal axis LA from the tubular body 118 towards the first tube end 110 of the tube 108. The actuating pipe 130 includes a first pipe end 132 distal to the tubular body 118 and an opposing second pipe end 134 disposed in fluid communication with the internal volume V1 of the tubular body 118. The actuating pipe 130 is configured to receive a pressurized fluid through the first pipe end 132.

In some embodiments, the probe 100 further includes a fluid pipe 136 (shown in FIGS. 2A and 2B) at least partially received within the internal passage 114 via the first tube end 110. The fluid pipe 136 is fluidly connected to the first pipe end 132 of the actuating pipe 130. The fluid pipe 136 is configured to supply the pressurized fluid to the actuating pipe 130 via the first pipe end 132, such that the flexible actuator 116 is remotely actuatable by the fluid pipe 136. Upon receiving the pressurized fluid within the internal volume V1 of the tubular body 118, the tubular body 118 inflates and axially expands along the longitudinal axis LA, thereby actuating the flexible actuator 116 from the non-actuated state S1 to the actuated state S2. The fluid may be water or air, or any other gas or liquid based on application requirements. In some embodiments, the flexible actuator 116 (i.e., the tubular body 118) is made of an elastomeric material. In some embodiments, the elastomeric material is silicone. In some embodiments, the elastomeric material may be rubber.

In some embodiments, the probe 100 further includes a pumping device 138 disposed in fluid communication with the fluid pipe 136 and located outside the tube 108. The pumping device 138 is configured to supply the pressurized fluid to the fluid pipe 136. The pumping device 138 may supply the pressurized fluid at a set pressure based on application requirements. In some embodiments, the pumping device 138 may be an air syringe (not shown) to supply pressurized air to the fluid pipe 136. In some embodiments, the pumping device 138 may be a hydraulic pump (not shown) to supply pressurized water to the fluid pipe 136.

In some embodiments, the tubular body 118 further includes a first end wall 140 disposed at the first body end 120. The tubular body 118 further includes a second end wall 142 disposed at the second body end 122. The first end wall 140 is connected to the actuating pipe 130. The first end wall 140 and the second end wall 142 together delimit the internal volume V1. The first end wall 140 defines an opening 144 (shown in FIGS. 4D and 4F) therethrough disposed in fluid communication with the first pipe end 132 and the internal volume V1. In other words, the opening 144 fluidly communicates the first pipe end 132 and the internal volume V1. Therefore, the internal volume V1 of the tubular body 118 receives the pressurized fluid from the fluid pipe 136 via the actuating pipe 130 and the opening 144 in the first end wall 140.

In some embodiments, the tubular body 118 includes a cylindrical outer surface 146 extending along the longitudinal axis LA. The tubular body 118 further includes a plurality of annular ribs 148 disposed on the cylindrical outer surface 146 and spaced apart from each other with respect to the longitudinal axis LA. The plurality of annular ribs 148 defines a plurality of annular grooves 150 therebetween, such that each pair of adjacent annular ribs 148 from the plurality of annular ribs 148 defines therebetween a corresponding annular groove 150 from the plurality of annular grooves 150. The plurality of annular ribs 148 includes a first annular rib 148a disposed proximal to the first body end 120 of the tubular body 118. The plurality of annular ribs 148 further includes a second annular rib 148b disposed proximal to the second body end 122 of the tubular body 118. In some embodiments, the plurality of annular ribs 148 includes a total of three annular ribs 148 and the plurality of annular grooves 150 includes a total of two annular grooves 150. In some embodiments, the plurality of annular ribs 148 includes more than three annular ribs 148 and the plurality of annular grooves 150 includes more than two annular grooves 150. A count of the plurality of annular ribs 148 and the corresponding plurality of annular grooves 150 may depend on application requirements.

In some embodiments, the probe 100 further includes a plurality of rings 152 (shown in FIGS. 3B and 3C) corresponding to the plurality of annular grooves 150. The plurality of rings 152 is disposed around the cylindrical outer surface 146 of the tubular body 118. Each ring 152 from the plurality of rings 152 is at least partially received within the corresponding annular groove 150. The plurality of rings 152 is configured to restrict a radial expansion of the tubular body 118 perpendicular to the longitudinal axis LA in response to the inflation by the pressurized fluid. In other words, the plurality of rings 152 may allow smooth switching of the flexible actuator 116 between the non-actuated state S1 and the actuated state S2 by allowing only axial movement of the flexible actuator 116 along the longitudinal axis LA. In some embodiments, the plurality of rings 152 includes a total of two rings 152 corresponding to two annular grooves 150 from the plurality of annular grooves 150. In some embodiments, each ring 152 is made of a rigid material (e.g., a plastic). A count of the plurality of annular ribs 148, the plurality of annular grooves 150, and the plurality of rings 152 may be decided based on required stiffness of the flexible actuator 116 for a particular application.

In some embodiments, the tubular body 118 further includes a wide tubular portion 154 extending along the longitudinal axis LA and defining the first body end 120 and the cylindrical outer surface 146. The tubular body 118 further includes a narrow tubular portion 156 extending from the wide tubular portion 154 along the longitudinal axis LA and defining the second body end 122. The wide tubular portion 154 includes an annular step surface 158 circumferentially disposed around the narrow tubular portion 156. The wide tubular portion 154 includes a first end section 160 extending between the first body end 120 and the first annular rib 148a. The wide tubular portion 154 further includes a second end section 162 extending between the annular step surface 158 and the second annular rib 148b. The wide tubular portion 154 and the narrow tubular portion 156 together form a continuous cylindrical internal surface 164 that defines the actuator passage 126.

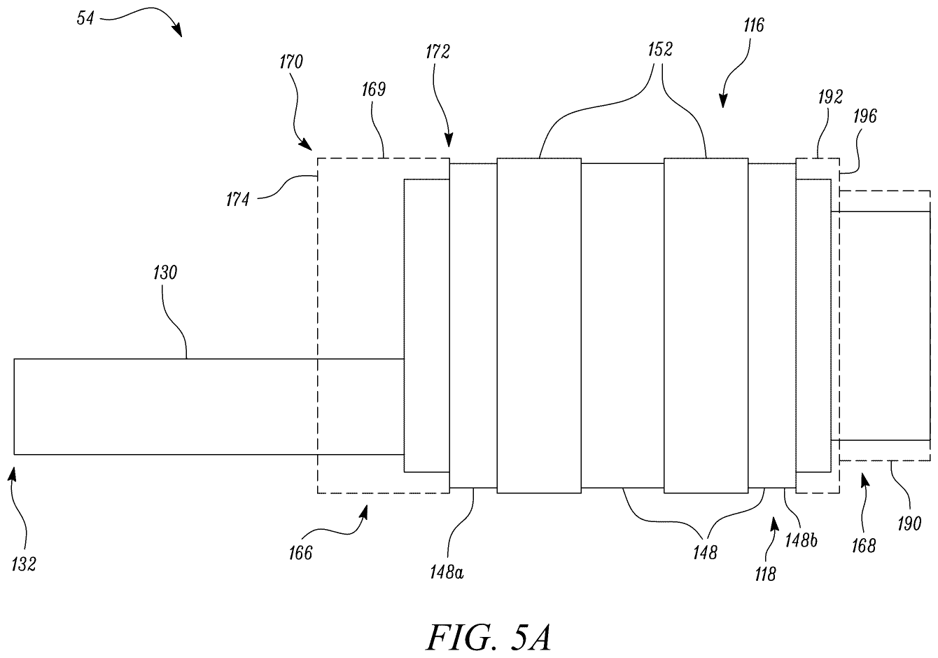

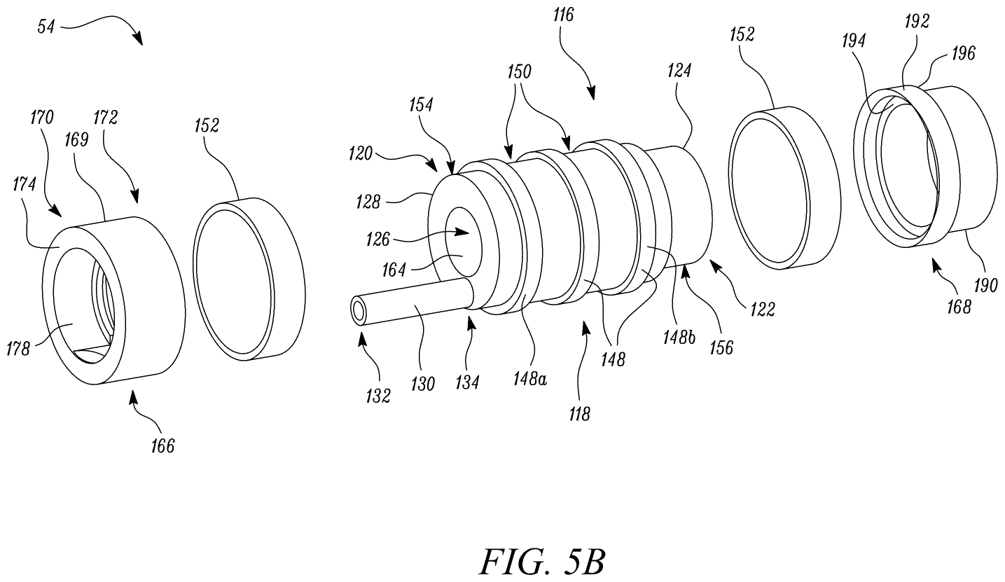

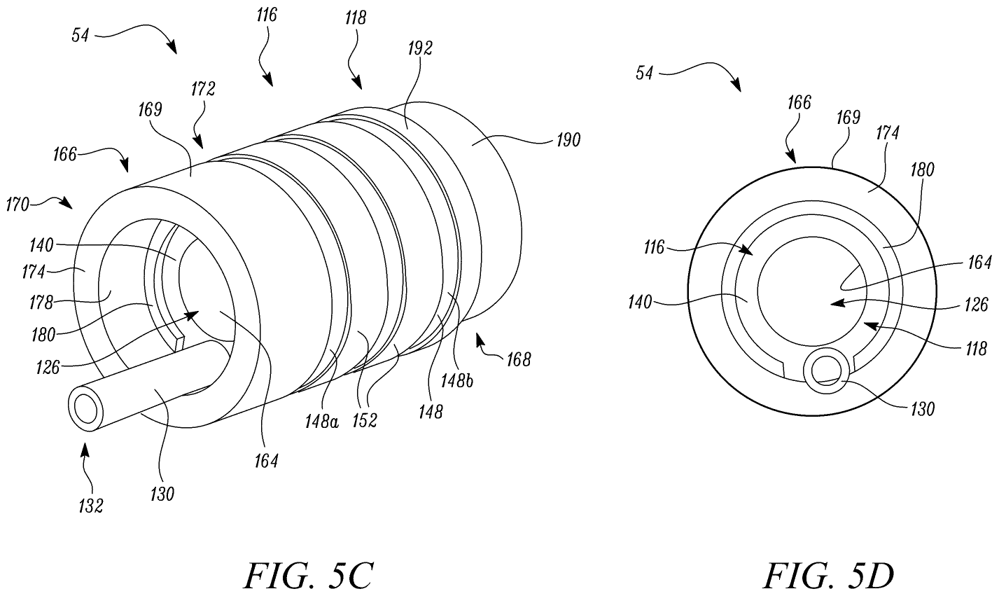

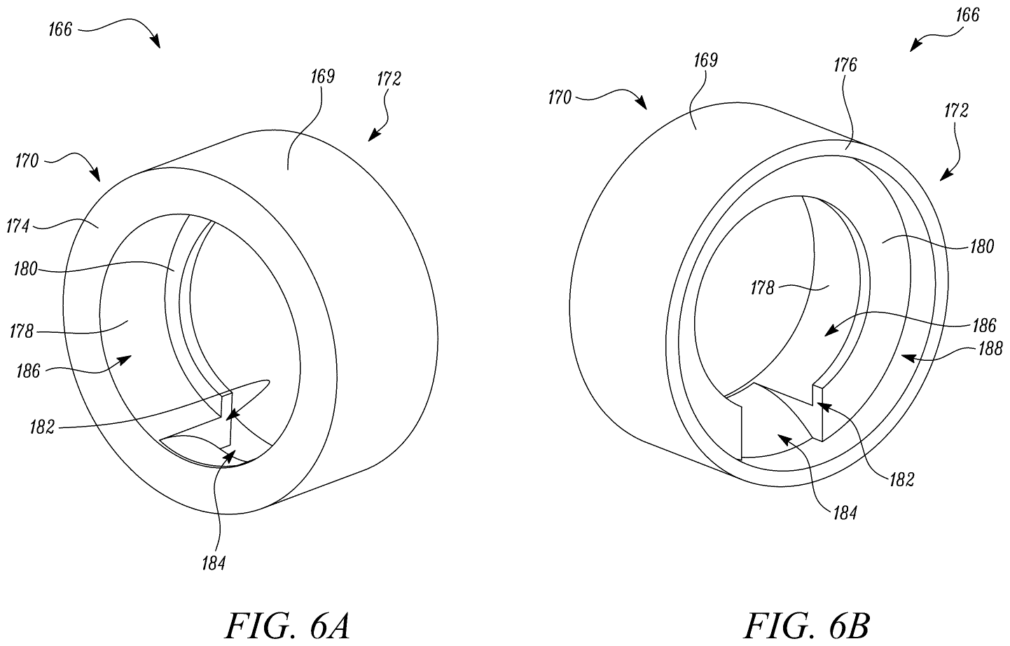

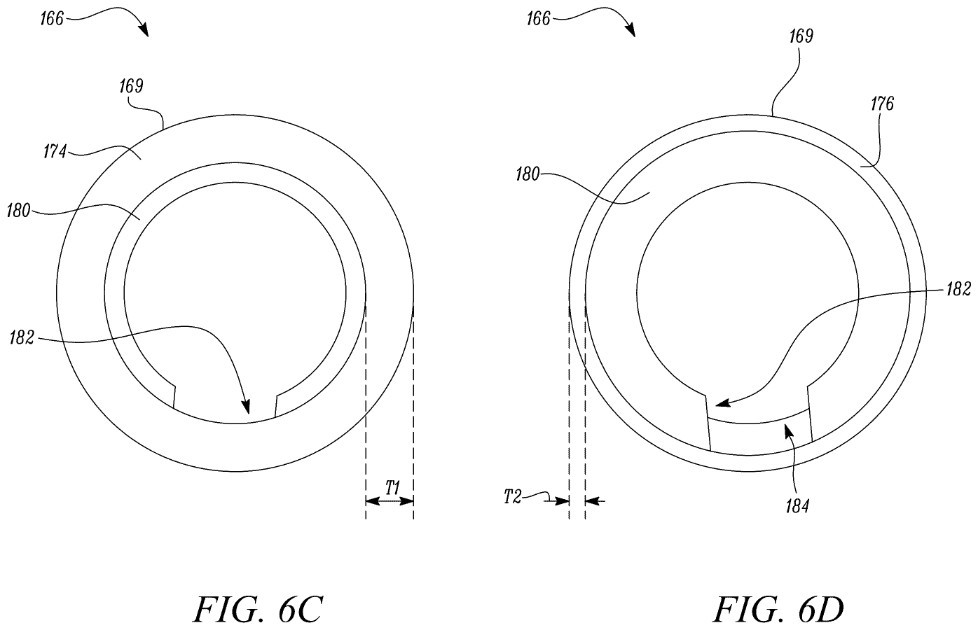

FIG. 5A is a side view of an assembly 54 of the flexible actuator 116, a first cover 166, and a second cover 168 of the probe 100 of FIG. 2A, according to an embodiment of the present disclosure. FIG. 5B is an exploded view of the assembly 54, according to an embodiment of the present disclosure. FIG. 5C is a perspective front view of the assembly 54, according to an embodiment of the present disclosure. FIG. 5D is a front view of the assembly 54, according to an embodiment of the present disclosure. FIG. 6A is a front perspective view of the first cover 166 of FIG. 5A, according to an embodiment of the present disclosure. FIG. 6B is a rear perspective view of the first cover 166, according to an embodiment of the present disclosure. FIG. 6C is a front view of the first cover 166, as viewed from the first open end 170, according to an embodiment of the present disclosure. FIG. 6D is a rear view of the first cover 166, as viewed from the second open end 172, according to an embodiment of the present disclosure.

Referring to FIGS. 2A to 6D, in some embodiments, the first cover 166 attaches the tubular body 118 to the second tube end 112 of the tube 108. The first cover 166 includes an annular body 169. The annular body 169 includes a first open end 170 facing the second tube end 112 of the tube 108, an opposing second open end 172, a first end surface 174 disposed at the first open end 170, a second end surface 176 (shown in FIGS. 6B and 6D) disposed at the second open end 172, and an internal surface 178 extending between the first end surface 174 and the second end surface 176. The first cover 166 further includes an annular stop 180 radially extending from the internal surface 178 of the annular body 169. The annular stop 180 is disposed proximal to the second end surface 176. The annular stop 180 includes a circumferential cut-out 182. The first cover 166 further includes a recess 184 disposed on the internal surface 178 of the annular body 169. The recess 184 extends from the circumferential cut-out 182 to the first end surface 174.

The first end surface 174 of the annular body 169 is attached to the second tube end 112 of the tube 108. The annular body 169 receives therein the first end section 160 of the wide tubular portion 154 via the second open end 172, such that the first end section 160 engages with the annular stop 180 and the first annular rib 148a engages with the second end surface 176. The first cover 166 functions as a connector to easily connect/disconnect the flexible actuator 116 and the tube 108. The annular stop 180, the circumferential cut-out 182, and the recess 184 may facilitate attachment of the tube 108 and the flexible actuator 116. The circumferential cut-out 182 fluidly communicates the internal passage 114 and the actuator passage 126. The first cover 166 may be attached to the tubular body 118 of the flexible actuator 116 by friction fit, or gluing. The first cover 166 may be attached to the second tube end 112 of the tube 108 by gluing, or other commonly known joining techniques.

In some embodiments, a thickness T1 of the first end surface 174 is greater than a thickness T2 of the second end surface 176. Further, the internal surface 178 includes a narrow surface portion 186 extending from the first end surface 174 to the annular stop 180. The internal surface 178 further includes a wide surface portion 188 extending from the annular stop 180 to the second end surface 176. Dimensions of the narrow surface portion 186 and the wide surface portion 188 are selected so as to allow precise attachment between the tube 108 and the flexible actuator 116. In some embodiments, the recess 184 tapers from the circumferential cut-out 182 to the first end surface 174. Specifically, the recess 184 tapers inwardly from the circumferential cut-out 182 to the first end surface 174. The recess 184 is configured to receive a portion of the actuating pipe 130. The tapered portion of the recess 184 may allow the actuating pipe 130 to at least partially extend or pass through the recess 184.

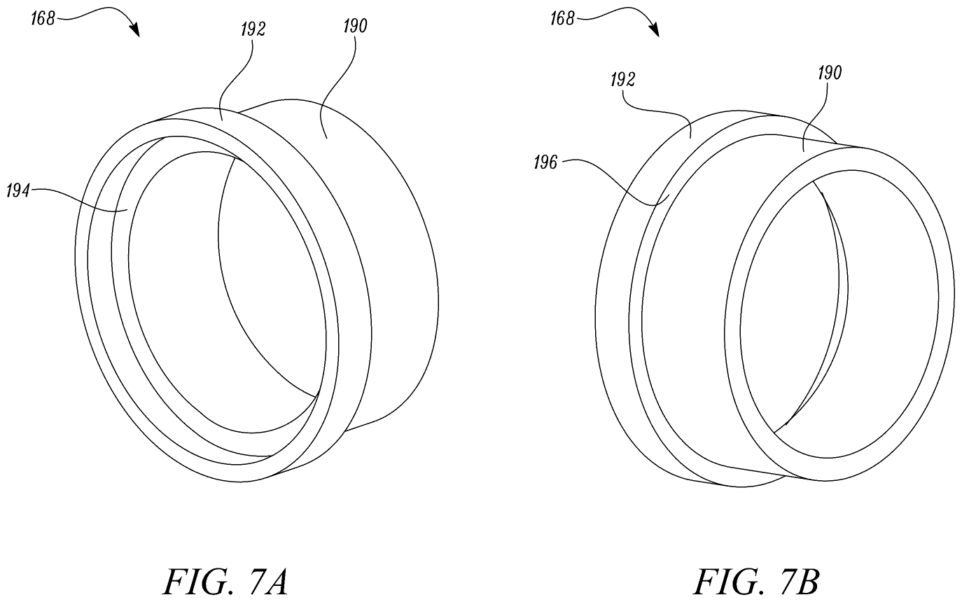

FIG. 7A is a front perspective view of the second cover 168, according to an embodiment of the present disclosure. FIG. 7B is a rear perspective view of the second cover 168, according to an embodiment of the present disclosure. Referring to FIGS. 2A to 7B, in some embodiments, the second cover 168 attaches the tubular body 118 to the head 102. The second cover 168 includes a narrow annular portion 190 and a wide annular portion 192 disposed around and extending at least partially from the narrow annular portion 190. The narrow annular portion 190 includes an inner annular step surface 194 extending circumferentially within the wide annular portion 192. The wide annular portion 192 includes an outer annular step surface 196 disposed circumferentially around the narrow annular portion 190. The narrow annular portion 190 at least partially receives therein the narrow tubular portion 156 of the tubular body 118, such that the inner annular step surface 194 engages with the annular step surface 158 of the wide tubular portion 154. The wide annular portion 192 receives therein the second end section 162 of the wide tubular portion 154, such that the wide annular portion 192 engages with the second annular rib 148b. The narrow annular portion 190 is at least partially received within the head 102 via the first head end 104.

The second cover 168 functions as a connector to easily connect/disconnect the flexible actuator 116 and the head 102. The second cover 168 may be attached to the tubular body 118 of the flexible actuator 116 by friction fit, or gluing. The second cover 168 may be attached to the first head end 104 of the head 102 by friction fit, gluing, or other commonly known joining techniques.

With reference to FIGS. 1 to 7B, the actuation of the flexible actuator 116 between the non-actuated state S1 and the actuated state S2 may allow the probe 100 to be used for non-destructive testing of the component 50 in confined spaces as well. As the actuated length L2 is greater than the non-actuated length L1, the flexible actuator 116 may remove limitations on a movement of the probe 100, especially for in-situ applications. As a result, the probe 100 may be able to effectively determine cracks and other flaws in the interior of the component 50. Moreover, due to extension of the flexible actuator 116 along the longitudinal axis LA upon switching the flexible actuator 116 from the non-actuated state S1 to the actuated state S2, the probe 100 of the present disclosure may be more effective as compared to conventional probes for non-destructive testing of a component with a curved surface. Therefore, the flexible actuator 116 may improve effectiveness and increase efficiency of the probe 100. The timely detection of cracks and irregularities in the component 50 may improve operational life of the component 50. The probe 100 may allow improved performance of the gas turbine engine 10 by timely determining the cracks and irregularities in the component 50 of the gas turbine engine 10.

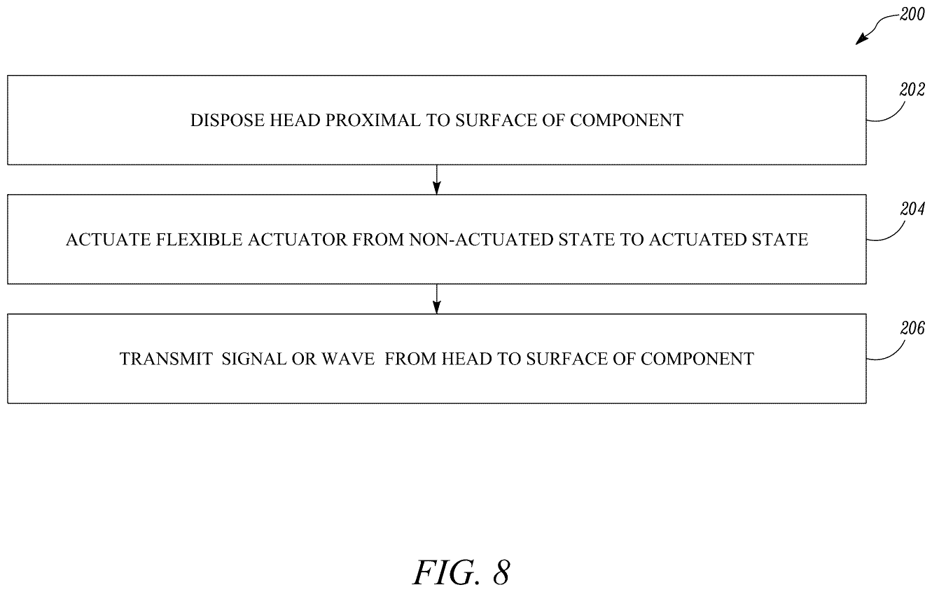

FIG. 8 is a flowchart illustrating a method 200 for non-destructive testing of the component 50 using the probe 100 of FIG. 2A, according to an embodiment of the present disclosure. Referring to FIGS. 2A, 2B, and 8, at step 202, the method 200 includes disposing, via the tube 108, the head 102 proximal to the surface 52 of the component 50. At step 204, the method 200 further includes actuating the flexible actuator 116 from the non-actuated state S1 to the actuated state S2, such that the second head end 106 of the head 102 is in contact with the surface 52 of the component 50. At step 206, the method 200 further includes transmitting a signal or a wave (e.g. acoustic waves) from the head 102 to the surface 52 of the component 50 for non-destructive testing of the component 50 using the probe 100.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A probe for non-destructive testing of a component, the probe comprising:
a head configured to transmit a signal or a wave to a surface of the component for non-destructive testing of the component, the head comprising a first head end facing away from the component and an opposing second head end facing the component, wherein the first head end is open;
a tube spaced apart from the head and comprising a first tube end distal to the head and an opposing second tube end proximal to the head, wherein each of the first tube end and the second tube end is open, the tube defining an internal passage therein extending between the first tube end and the second tube end; and
a flexible actuator disposed between the head and the tube, wherein the flexible actuator is attached with the first head end of the head and the second tube end of the tube, the flexible actuator defining a longitudinal axis along its length and configured to be actuated between a non-actuated state and an actuated state, wherein, in the non-actuated state, the flexible actuator extends for a non-actuated length along the longitudinal axis, wherein, in the actuated state, the flexible actuator expands axially along the longitudinal axis relative to the non-actuated state and extends for an actuated length along the longitudinal axis, and wherein the actuated length is greater than the non-actuated length, wherein, upon switching the flexible actuator from the actuated state to the non-actuated state, the flexible actuator returns to the non-actuated length, and wherein the flexible actuator is remotely actuatable from the first tube end between the non-actuated state and the actuated state.

2. The probe of claim 1, wherein the flexible actuator comprises:
a tubular body extending along the longitudinal axis between a first body end facing the tube and an opposing second body end facing the head, the tubular body comprising an inner annular portion defining an actuator passage therethrough and an outer annular portion disposed around the inner annular portion, wherein the actuator passage fluidly connects the internal passage of the tube with the head, wherein the inner annular portion and the outer annular portion define an internal volume therebetween, such that the tubular body is inflatable; and
an actuating pipe connected to the tubular body and extending along the longitudinal axis from the tubular body towards the first tube end of the tube, the actuating pipe comprising a first pipe end distal to the tubular body and an opposing second pipe end disposed in fluid communication with the internal volume of the tubular body, wherein the actuating pipe is configured to receive a pressurized fluid through the first pipe end;
wherein, upon receiving the pressurized fluid within the internal volume of the tubular body, the tubular body inflates and axially expands along the longitudinal axis, thereby actuating the flexible actuator from the non-actuated state to the actuated state.

3. The probe of claim 2, wherein the tubular body further comprises a first end wall disposed at the first body end and a second end wall disposed at the second body end, wherein the first end wall is connected to the actuating pipe, wherein the first end wall and the second end wall together delimit the internal volume, and wherein the first end wall defines an opening therethrough disposed in fluid communication with the first pipe end and the internal volume.

4. The probe of claim 2, further comprising a fluid pipe at least partially received within the internal passage via the first tube end and fluidly connected to the first pipe end of the actuating pipe, wherein the fluid pipe is configured to supply the pressurized fluid to the actuating pipe via the first pipe end, such that the flexible actuator is remotely actuatable by the fluid pipe.

5. The probe of claim 4, further comprising a pumping device disposed in fluid communication with the fluid pipe and located outside the tube, wherein the pumping device is configured to supply the pressurized fluid to the fluid pipe.

6. The probe of claim 2, wherein the tubular body comprises a cylindrical outer surface extending along the longitudinal axis and a plurality of annular ribs disposed on the cylindrical outer surface and spaced apart from each other with respect to the longitudinal axis, wherein the plurality of annular ribs defines a plurality of annular grooves therebetween, such that each pair of adjacent annular ribs from the plurality of annular ribs defines therebetween a corresponding annular groove from the plurality of annular grooves, and wherein the plurality of annular ribs comprises a first annular rib disposed proximal to the first body end of the tubular body and a second annular rib disposed proximal to the second body end of the tubular body.

7. The probe of claim 6, further comprising a plurality of rings corresponding to the plurality of annular grooves and disposed around the cylindrical outer surface of the tubular body, wherein each ring from the plurality of rings is at least partially received within the corresponding annular groove, and wherein the plurality of rings is configured to restrict a radial expansion of the tubular body perpendicular to the longitudinal axis in response to the inflation by the pressurized fluid.

8. The probe of claim 7, wherein each ring is made of a rigid material.

9. The probe of claim 6, wherein the tubular body further comprises a wide tubular portion extending along the longitudinal axis and defining the first body end and the cylindrical outer surface, and a narrow tubular portion extending from the wide tubular portion along the longitudinal axis and defining the second body end, wherein the wide tubular portion comprises an annular step surface circumferentially disposed around the narrow tubular portion, wherein the wide tubular portion comprises a first end section extending between the first body end and the first annular rib, and a second end section extending between the annular step surface and the second annular rib, and wherein the wide tubular portion and the narrow tubular portion together form a continuous cylindrical internal surface that defines the actuator passage.

10. The probe of claim 9, further comprising a first cover attaching the tubular body to the second tube end, wherein the first cover comprises:
an annular body comprising a first open end facing the second tube end of the tube, an opposing second open end, a first end surface disposed at the first open end, a second end surface disposed at the second open end, and an internal surface extending between the first end surface and the second end surface;
an annular stop radially extending from the internal surface of the annular body and disposed proximal to the second end surface, the annular stop comprising a circumferential cut-out; and
a recess disposed on the internal surface of the annular body and extending from the circumferential cut-out to the first end surface;
wherein the first end surface of the annular body is attached to the second tube end of the tube; and
wherein the annular body receives therein the first end section of the wide tubular portion via the second open end, such that the first end section engages with the annular stop and the first annular rib engages with the second end surface.

11. The probe of claim 10, wherein a thickness of the first end surface is greater than a thickness of the second end surface, and wherein the internal surface comprises a narrow surface portion extending from the first end surface to the annular stop and a wide surface portion extending from the annular stop to the second end surface.

12. The probe of claim 10, wherein the recess tapers from the circumferential cut-out to the first end surface.

13. The probe of claim 9, further comprising a second cover attaching the tubular body to the head, wherein the second cover comprises a narrow annular portion and a wide annular portion disposed around and extending at least partially from the narrow annular portion, wherein the narrow annular portion comprises an inner annular step surface extending circumferentially within the wide annular portion, wherein the wide annular portion comprises an outer annular step surface disposed circumferentially around the narrow annular portion, wherein the narrow annular portion at least partially receives therein the narrow tubular portion of the tubular body, such that the inner annular step surface engages with the annular step surface of the wide tubular portion, wherein the wide annular portion receives therein the second end section of the wide tubular portion, such that the wide annular portion engages with the second annular rib, and wherein the narrow annular portion is at least partially received within the head via the first head end.

14. The probe of claim 1, wherein the flexible actuator is integrally manufactured by additive manufacturing.

15. The probe of claim 1, wherein the flexible actuator is made of an elastomeric material.

16. The probe of claim 1, wherein the probe is an ultrasonic probe that is configured to transmit ultrasonic waves to the surface of the component.

17. A method for non-destructive testing of a component using the probe of claim 1, the method comprising the steps of:
disposing, via the tube, the head proximal to a surface of the component;
actuating the flexible actuator from the non-actuated state to the actuated state, such that the second head end of the head is in contact with the surface of the component; and
transmitting a signal or wave from the head to the surface of the component.

18. The method of claim 17, wherein the component is an engine component.

19. The method of claim 18, wherein the engine component is a component of a gas turbine engine.

20. The method of claim 17, wherein the component is a component of a pipeline, a nuclear plant, or a chemical plant.
